(19) United States
(12) Patent Application Publication
(10) Pub. No.: US 2020/0149516 A1
(43) Pub. Date: May 14, 2020

(54) LIQUID-SOLID PHASE CHANGE POWER GENERATION

(71) Applicant: Joshua N. Kramer, Bainbridge Island, WA (US)

(72) Inventor: Joshua N. Kramer, Bainbridge Island, WA (US)

(21) Appl. No.: 16/191,317

(22) Filed: Nov. 14, 2018

(51) Int. Cl. F03G 7/06; F25C 1/25

(52) U.S. Cl. CPC F03G 7/06; F25C 2700/04; F25C 1/25

(57) ABSTRACT

A system for generating mechanical work from the expansion of water as it freezes includes an outer housing, an inner housing, and a chamber between the outer housing and the inner housing. Water may be supplied to the chamber and a coolant may be supplied around the outer housing and inside the inner housing. As the water freezes, its volumetric expansion may force a piston to move, generating useful mechanical work.

### BACKGROUND

### Technical Field

The present disclosure relates generally to systems and methods for generating mechanical work from a liquid-solid phase change, and more particularly to systems and methods for generating mechanical work from the expansion of water as it freezes.

### Description of the Related Art

Various systems have been developed to generate mechanical work from phase changes. As an example, a steam engine can generate mechanical work as a liquid such as water vaporizes into its gaseous form. Water is unusual in that it expands as it freezes. Generating mechanical work from liquid-gas phase changes can be more efficient in many cases than generating mechanical work from liquid-solid phase changes given the characteristics of such phase changes.

### BRIEF SUMMARY

A system for generating mechanical work from a liquid-solid phase change may be summarized as comprising: a tank; an outer housing at least partially inside the tank, the outer housing having an inner surface; an inner housing at least partially inside the outer housing, the inner housing having an outer surface; a piston located inside the outer housing and outside the inner housing, the piston having an outer surface engaged with the inner surface of the outer housing, the piston having an inner surface engaged with the outer surface of the inner housing; an outer chamber between the tank and the outer housing; a first coolant within the outer chamber, the first coolant at a temperature below zero degrees Celsius; an intermediate chamber between the inner surface of the outer housing and the outer surface of the inner housing; liquid water within the intermediate chamber; an inner chamber inside the inner housing; and a second coolant within the inner chamber, the second coolant at a temperature below zero degrees Celsius.

The outer housing may include an air intake valve that allows air to flow into and out of the intermediate chamber. The outer housing may be cylindrical, the inner housing may be cylindrical, and the intermediate chamber may be annular. The system may further comprise a hydraulic fluid chamber inside the outer housing and a hydraulic fluid inside the hydraulic fluid chamber. The piston may separate the intermediate chamber from the hydraulic fluid chamber and may separate the liquid water from the hydraulic fluid. The system may further comprise a hydraulic cylinder coupled to the outer housing and a second piston inside the hydraulic cylinder. When the liquid water freezes, expansion of the liquid water may cause movement of the piston, movement of the piston may cause the hydraulic fluid to flow, and flow of the hydraulic fluid may cause movement of the second piston. Movement of the second piston may cause a second hydraulic fluid to flow into an accumulator, a hydraulic alternator, and/or a hydraulic motor.

The system may further comprise: a second outer housing at least partially inside the tank, the second outer housing having a second inner surface; a second inner housing at least partially inside the second outer housing, the second inner housing having a second outer surface; a second piston located inside the second outer housing and outside the second inner housing, the second piston having a second outer surface engaged with the second inner surface of the second outer housing, the second piston having a second inner surface engaged with the second outer surface of the second inner housing; a second outer chamber between the tank and the second outer housing; a third coolant within the second outer chamber, the third coolant at a temperature below zero degrees Celsius; a second intermediate chamber between the second inner surface of the second outer housing and the second outer surface of the second inner housing; liquid water within the second intermediate chamber; a second inner chamber inside the second inner housing; and a fourth coolant within the second inner chamber, the fourth coolant at a temperature below zero degrees Celsius.

A method of generating mechanical work from a liquid-solid phase change may be summarized as comprising: supplying liquid water to an intermediate chamber between an outer housing and an inner housing; supplying a first coolant to an outer chamber between a tank and the outer housing, the first coolant at a temperature below zero degrees Celsius; supplying a second coolant to an inner chamber inside the inner housing, the second coolant at a temperature below zero degrees Celsius; and allowing the liquid water to freeze inside the intermediate chamber as heat is transferred from the liquid water through the outer housing to the first coolant and through the inner housing to the second coolant, the freezing of the water forcing a piston to move between the outer housing and the inner housing along a length of the outer housing and along a length of the inner housing.

The method may further comprise opening a door of the outer housing and removing frozen water from the intermediate chamber. The method may further comprise: supplying liquid water to a second intermediate chamber between a second outer housing and a second inner housing; supplying a third coolant to a second outer chamber between the tank and the second outer housing, the third coolant at a temperature below zero degrees Celsius; supplying a fourth coolant to a second inner chamber inside the second inner housing, the fourth coolant at a temperature below zero degrees Celsius; and allowing the liquid water to freeze inside the second intermediate chamber as heat is transferred from the liquid water through the second outer housing to the third coolant and through the second inner housing to the fourth coolant, the freezing of the water forcing a second piston to move between the second outer housing and the second inner housing along a length of the second outer housing and along a length of the second inner housing. A freezing cycle of water within the intermediate chamber may be offset from a freezing cycle of water within the second intermediate chamber.

### BRIEF DESCRIPTION OF THE SEVERAL VIEWS OF THE DRAWINGS

FIG. 1A illustrates a system for generating mechanical work from the expansion of water as it freezes, according to one implementation.

FIG. 1B illustrates the system of FIG. 1A with a door at one end thereof open to release frozen water, according to one implementation.

FIG. 2A illustrates a cross-sectional view of the system of FIG. 1, with water in its liquid phase, according to one implementation.

FIG. 2B illustrates a cross-sectional view of the system of FIG. 1, with water in its solid phase, according to one implementation.

FIG. 2C illustrates a cross-sectional view of the system of FIG. 1, with water in its solid phase being released from a cylinder thereof, according to one implementation.

FIG. 2D illustrates a cross-sectional view of the system of FIG. 1, with water in its liquid phase being loaded into a cylinder thereof, according to one implementation.

FIG. 3 illustrates a larger portion of FIG. 2D, as indicated in FIG. 2D, according to one implementation.

FIG. 4 illustrates a plurality of systems for generating mechanical work from the expansion of water as it freezes, according to one implementation.

FIG. 5 illustrates an exploded view of a hydraulic accumulator that can be hydraulically coupled to the system of FIG. 1, according to one implementation.

FIG. 6 illustrates a cross-sectional view of the hydraulic accumulator of FIG. 5 in an assembled configuration, according to one implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with the technology have not been shown or described in detail to avoid unnecessarily obscuring descriptions of the implementations.

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations. Also, as used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The use of ordinals such as first, second and third does not necessarily imply a ranked sense of order, but rather may only distinguish between multiple instances of an act or structure.

Terms of geometric alignment may be used herein. Any components of the implementations that are illustrated, described, or claimed herein as being aligned, arranged in the same direction, parallel, or having other similar geometric relationships with respect to one another have such relationships in the illustrated, described, or claimed implementations. In alternative implementations, however, such components can have any of the other similar geometric properties described herein indicating alignment with respect to one another. Any components of the implementations that are illustrated, described, or claimed herein as being not aligned, arranged in different directions, not parallel, perpendicular, transverse, or having other similar geometric relationships with respect to one another, have such relationships in the illustrated, described, or claimed implementations. In alternative implementations, however, such components can have any of the other similar geometric properties described herein indicating non-alignment with respect to one another.

Various examples of suitable dimensions of components and other numerical values may be provided herein. In the illustrated, described, and claimed implementations, such dimensions are accurate to within standard manufacturing tolerances unless stated otherwise. Such dimensions are examples, however, and can be modified to produce variations of the components and systems described herein. In various alternative implementations, such dimensions and any other specific numerical values provided herein can be approximations wherein the actual numerical values can vary by up to 1, 2, 5, 10, 15 or more percent from the stated, approximate dimensions or other numerical values.

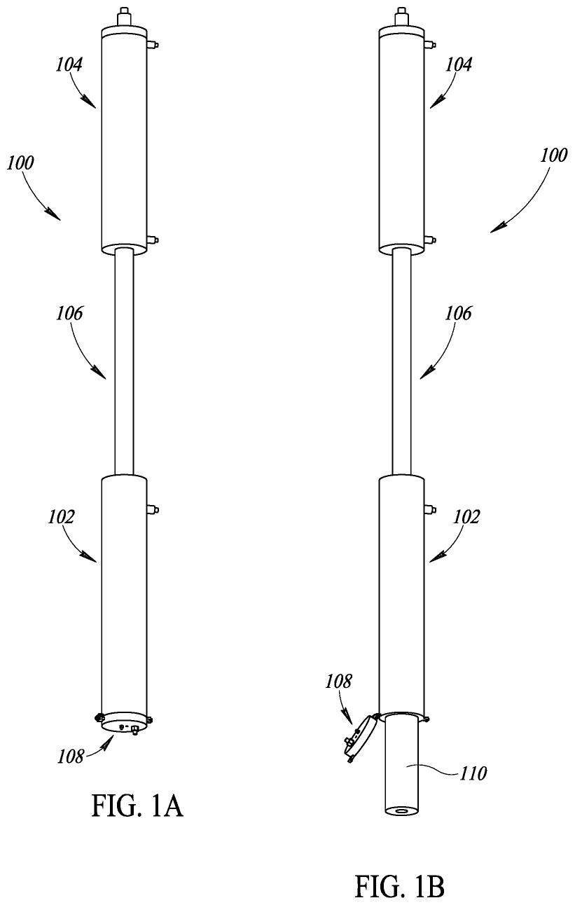

FIG. 1A illustrates a system 100 for generating mechanical work from a liquid-solid phase change, such as from the expansion of water as it freezes. As illustrated in FIG. 1A, the system 100 includes a first cylinder 102, which may also be referred to as an outer housing, at a first end thereof, which may be a lower end thereof, a second cylinder 104 at a second end thereof, which may be an upper end thereof, and a third cylinder 106 that is positioned between the first cylinder 102 and the second cylinder 104, and that extends from a first, proximal end of the first cylinder 102, such as an upper end thereof, to a first, proximal end of the second cylinder 104, such as a lower end thereof. The third cylinder 106 may fluidically, hydraulically, and/or mechanically couple an inner chamber of the first piston 102 to an inner chamber of the second piston 104.

As used herein, terms of relative elevation, such as “top,” “bottom,” “upper,” lower,” “above,” “below,” “up,” and “down,” are used in their ordinary sense, that is, with respect to a direction of a gravitational force, such that gravity pulls objects down. Features, portions, or components of the systems described herein may be described using such terminology. Nevertheless, alternative implementations of the systems described herein may include such features, portions, or components oriented in other directions than those described and/or illustrated, such as upside down, sideways, or at oblique angles with respect to the orientations described and/or illustrated herein.

The first cylinder 102, second cylinder 104, and/or third cylinder 106 can have cylindrical shapes with central longitudinal axes that are coincident with one another. As used herein, terms such as “proximal” and “distal” are used with reference to the central longitudinal axes of the first, second, and third cylinders 102, 104, and 106, such that features labeled as “proximal” are located relatively close to the center of the system 100 along the central longitudinal axes, and such that features labeled as “distal” are located relatively far from the center of the system 100 along the central longitudinal axes.

In operation, an inner chamber of the first cylinder 102, which may also be referred to as an intermediate chamber, may be filled or supplied with liquid water and an inner chamber of the second cylinder 104 may be filled or supplied with a hydraulic fluid, and a piston and/or a piston rod may be positioned at least partially within the third cylinder 106. The first cylinder 102 may then be chilled to cause the liquid water to freeze therein. As the liquid water freezes within the first cylinder 102, it also expands. The expansion of the water within the cylinder 102 may displace the piston and/or the piston rod, and the displacement of the piston and/or the piston rod may in turn pressurize and/or displace the hydraulic fluid within the second cylinder 104, such that the hydraulic fluid can be used to generate or do mechanical work.

FIG. 1A illustrates that the first cylinder 102 includes a door 108 that in a closed position covers a port at a second, distal end of the first cylinder 102, such as a bottom end thereof. FIG. 1B illustrates the system 100 with the door 108 in an open position. As illustrated in FIG. 1B, once the door 108 is moved to the open position, frozen water or ice 110 can be removed from the first piston 102, such as through the port at the bottom end thereof. In operation, the system 100 can perform in cycles, wherein water is loaded into the first cylinder 102, the water is then frozen within the first cylinder 102 to move the piston and/or the piston rod, and the frozen water is then removed from the first cylinder 102. Such a cycle may be repeated as frequently and for as long as is workable and for as long as is desired.

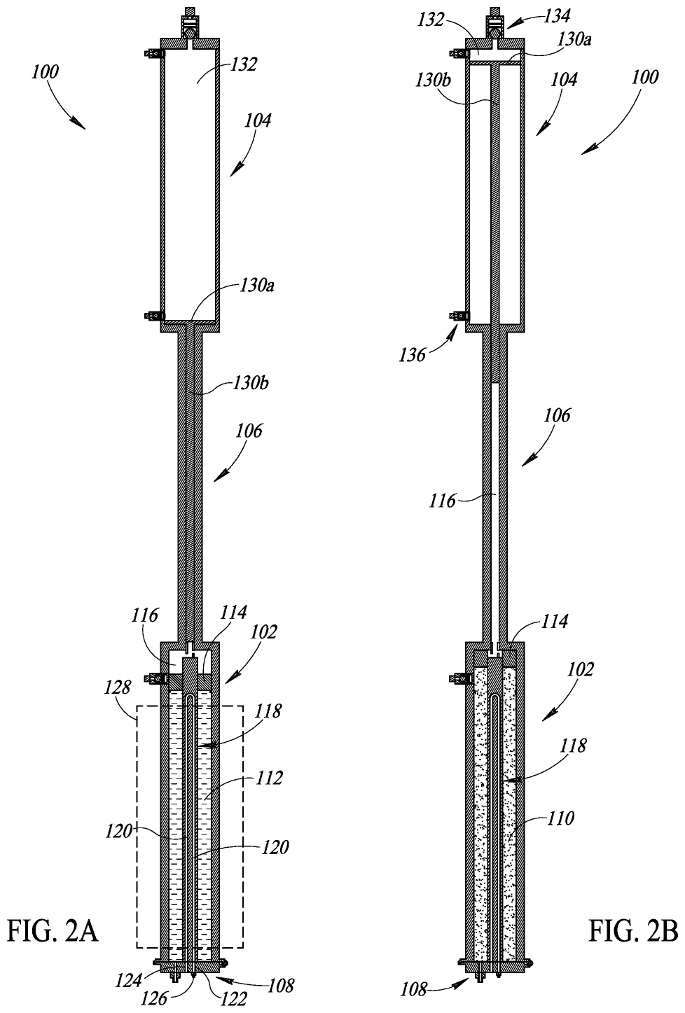

FIG. 2A illustrates a cross-sectional view of the system 100 in a first configuration, in which liquid water 112 has been loaded into a first, distal inner chamber within the first cylinder 102. As illustrated in FIG. 2A, a first piston 114 is located within the first cylinder 102. In the first configuration illustrated in FIG. 2A, the first piston 114 separates the first, distal inner chamber within the first cylinder 102, which may be a lower inner chamber thereof, from a second, proximal inner chamber within the first cylinder 102, which may be an upper inner chamber thereof. As illustrated in FIG. 2A, the liquid water fills the first, lower inner chamber of the first cylinder 102 and a first hydraulic fluid 116 fills the second, upper inner chamber of the first cylinder 102. The first piston 114 creates a fluid-tight seal between the two inner chambers of the first cylinder 102, such that the liquid water 112 and the first hydraulic fluid 116 do not mix.

As also illustrated in FIG. 2A, a second piston 130, which includes a relatively wide piston head 130a fixedly and integrally coupled to a relatively narrow rod 130b, is positioned such that the piston head 130a is located inside the second cylinder and adjacent the first end of the second cylinder 104, and such that the rod 130b is located within an inner chamber within the third cylinder 106, extending from the piston head 130a to the first end of the first cylinder 102. Thus, in the configuration illustrated in FIG. 2A, the second piston 130 is located at a lower, proximal end of its stroke length such that an underside or lower surface of the piston head 130a lies against an upward-facing surface of the second cylinder 104 at the bottom end of an inner chamber thereof. As also illustrated in FIG. 2A, a second hydraulic fluid 132 fills an inner chamber of the second cylinder 104.

FIG. 2A also illustrates that the system 100 includes a central core or an inner cooling cylinder 118, which may also be referred to as an inner housing, located within the first cylinder 102. As illustrated in FIG. 2A, the cooling cylinder 118 is positioned within and concentrically with respect to the first cylinder 102, and extends from the door 108 at the bottom end of the first cylinder 102, all the way through the first inner chamber housing the liquid water 112, to a top end of the second inner chamber housing the first hydraulic fluid 116 at or proximate the first end of the first cylinder 102. Thus, the liquid water 112 can occupy an annular space defined between an outer surface of the cooling cylinder 118 and an inner surface of the first cylinder 102. As illustrated in FIG. 2A, the first piston 114 is mounted on the outer surface of the cooling cylinder 118 and extends and spans through the annular space from the outer surface of the cooling cylinder 118 to the inner surface of the first cylinder 102, such that the first piston 114 can slide longitudinally along the cooling cylinder 118 through the first cylinder 102.

As also illustrated in FIG. 2A, the cooling cylinder 118 includes an internal conduit 120, which may also be referred to as an inner chamber, that extends from a bottom, distal end thereof adjacent to the door 108, upwards along most of the length of the cooling cylinder 118 to a location proximate a top, proximal end of the cooling cylinder 118 opposite the bottom end thereof proximate the door 108. As illustrated in FIG. 2A, at the location proximate the top end of the cooling cylinder 118, the internal conduit 120 turns a 180-degree corner and extends from the location proximate the top end of the cooling cylinder 118, downwards along the length of the cooling cylinder 118, and to the bottom end of the cooling cylinder adjacent to the door 108. Thus, the internal conduit 120 extends through the cooling cylinder 118 from an inlet thereof to an outlet thereof, where the inlet and the outlet are located in the bottom end of the cooling cylinder 118.

The first cylinder 102 and the cooling cylinder 118 may be made of copper, which, given its high thermal conductivity, can conduct heat relatively rapidly out of water 112 within the first chamber within the first cylinder 102 to accelerate freezing of the water 112. Providing the cooling cylinder 118 within the first cylinder 102 increases a ratio of the surface area to volume within the first chamber of the first cylinder 102, as well as decreases an average distance between the copper walls and the individual water molecules, thereby accelerating the freezing of water within the first cylinder 102.

As also illustrated in FIG. 2A, the door 108 includes a first conduit 122 that extends from an upper, proximal end of the door 108 adjacent the bottom end of the cooling cylinder 118 to a bottom, distal end of the door 108, and a second conduit 124 that extends from an upper end of the door 108 adjacent the bottom end of the cooling cylinder 118 to a bottom end of the door 108. When the door 108 is in the closed position, the first and second conduits 122, 124 are each fluidically coupled to a respective end of the internal conduit 120, such that a fluid can flow into and out of the internal conduit 120 through the first and second conduits 122, 124. The first and/or the second conduit 122, 124 can be fitted with a valve 126 through which a coolant can be fed into and/or out of the internal conduit 120 of the cooling cylinder 118 in a controlled manner. As also illustrated in FIG. 2A, the system 100 may include an insulated reservoir or tank 128 or other container that defines an outer chamber that at least partially, or completely, surrounds the first cylinder 102.

FIG. 2B illustrates a cross-sectional view of the system 100 in a second configuration, in which the liquid water 112 has solidified and been converted into the frozen water 110. As examples, the water can be solidified or frozen by circulating chilled salt water (at, as an example, about −15 degrees Celsius) through the internal conduit 120 within the cooling cylinder 118, and by circulating chilled salt water through the tank 128. The salt water used in such implementations may be chilled to below zero degrees Celsius, such that heat can be transferred out of the liquid water 112, through the first cylinder 102 and/or the cooling cylinder 118, and into the salt water, until the water within the first cylinder 102 freezes and/or until the temperatures reach equilibrium. As can be seen by comparing FIGS. 2A and 2B, the solidification or freezing of the water is accompanied by physical, volumetric expansion of the water, which forces the first piston 114 to move proximally upward along the cooling cylinder 118 away from the door 108 and toward the second cylinder 104. For example, the water may experience volumetric expansion of about 9% as it freezes.

By forcing the first piston 114 to move proximally toward the second cylinder 106 in this manner, the freezing of the water also pressurizes the first hydraulic fluid 116 and forces the first hydraulic fluid 116 to move proximally and flow upward into and through the inner chamber within the third cylinder 106, and toward the second cylinder 104. By forcing the first hydraulic fluid 116 to move toward the second cylinder 106 in this manner, the freezing of the water also forces the second piston 130 to move distally upward through inner chambers of the second and third cylinders 104, 106, away from the door 108 and toward a second, distal end of the second cylinder 104 opposite to the first end thereof, which may be an upper end of the second cylinder 104. By forcing the second piston 130 to move in this manner, the freezing of the water also pressurizes the second hydraulic fluid 132 and forces the second hydraulic fluid 132 to move distally and flow out of the second cylinder 104 to do or perform useful mechanical work.

As illustrated in FIG. 2B, an outer diameter of the piston head 130a is larger than an outer diameter of the rod 130b. Thus, use of the second piston 130 reduces or steps down the pressure from the first hydraulic fluid 116 to the second hydraulic fluid 132, while increasing the volumetric displacement of the second hydraulic fluid 132 relative to the volumetric displacement of the first hydraulic fluid 132. For example, the freezing of water within the first cylinder 102 can generate pressures up to 200 MPa, and these pressures may be reduced to operating pressures for a hydraulic alternator and/or a hydraulic motor by the piston 130.

As illustrated in FIG. 2B, the second cylinder 104 includes a hydraulic fluid outlet fitted with a hydraulic fluid outlet valve 134 at the distal end of the second cylinder 104, through which the hydraulic fluid can flow as the water freezes in the first cylinder 102. As also illustrated in FIG. 2B, the second cylinder 104 includes an air inlet and outlet fitted with an air intake valve 136 at a proximal end of the second cylinder 104, which may allow air into or out of the second cylinder at a location underneath, or proximal with respect to, the piston head 130a. In particular, as the second piston 130 travels along its stroke length from the position illustrated in FIG. 2A, a first inner chamber is created inside the second cylinder 104 in the space opened up between the underside of the piston head 130a and the inner surfaces of the bottom, proximal end portion of the second cylinder 104. Thus, the air intake valve 136 can allow air into this first inner chamber to prevent the formation of a vacuum therein.

In the second configuration illustrated in FIG. 2B, the piston head 130a separates the first, proximal inner chamber within the second cylinder 104, which may be a lower inner chamber thereof, from a second, distal inner chamber within the second cylinder 104, which may be an upper inner chamber thereof and which houses the second hydraulic fluid 132. The second piston 132 creates a fluid-tight seal between the two inner chambers of the second cylinder 104, such that the air and the second hydraulic fluid 132 do not mix. The valves 134 and 136, as well as any of the other valves described herein, may be ball valves and/or check valves or any other type of valves suitable for their operation as described herein.

FIG. 2C illustrates a cross-sectional view of the system 100 in a third configuration, in which the frozen water 110 is being removed from the first cylinder 102. As illustrated in FIG. 2C, the door 108 is coupled to the rest of the first cylinder 102 by a hinge 138, such that the door 108 can be opened by rotating it about the hinge 138 away from the port in the bottom, distal end of the first cylinder 102. Once the door 108 is opened in this manner, the solidified or frozen water can be removed from the first cylinder 102 through the port in its bottom end, such as by a human operator or by a mechanical system configured to perform such a task. In some cases, the liquid water 112 supplied to the first chamber within the first cylinder 102, as illustrated in FIG. 2A, can include one or more oils, such as to make the water more flowable, and/or to ease the removal of the frozen water 110 from the first cylinder 102. Similarly, one or more lubricants can be applied to the inner surface of the first cylinder 102 prior to supplying the liquid water 112 into the first cylinder 102, such as to ease the removal of the frozen water 110 from the first cylinder 102. FIG. 2C illustrates the frozen water 110 partially removed from the first cylinder 102, but the frozen water 110 can be completely removed from the first cylinder 102 as described herein. Once the frozen water 110 is completely removed from the first cylinder 102, it can be melted and then re-used in a later freezing cycle.

As also illustrated in FIG. 2C, the first cylinder 102 includes an air inlet and outlet fitted with an air intake valve 146, which may allow air into or out of the first cylinder 102 at a location just underneath, or distal with respect to, the first piston 114, proximate the top end of the solidified or frozen water 110 before it is removed from the first cylinder 102. In particular, as the solidified or frozen water 110 is removed from the first cylinder 102 and travels along the length thereof, an empty space is created and opened up inside the first cylinder 102 between the underside of the first piston 114 and the upper surface of the solidified water 110. Thus, the air intake valve 146 can allow air into this empty space to prevent the formation of a vacuum therein. In some implementations, a pressurized liquid or a pressurized gas, such as pressurized water or pressurized air, can be supplied into this empty space to assist in removing the frozen water 110 from the first cylinder 102.

FIG. 2D illustrates a cross-sectional view of the system 100 in a fourth configuration, in which the second hydraulic fluid 132 is being loaded into the second cylinder 104 and liquid water 112 is being loaded into the first cylinder 102. As illustrated in FIG. 2D, the second cylinder 104 includes a hydraulic fluid inlet fitted with a hydraulic fluid inlet valve 140 at the distal, top end of the second cylinder 104, through which the second hydraulic fluid 132 can flow to load the second cylinder 104 with the second hydraulic fluid 132. After the solidified or frozen water 110 is removed from the first cylinder 102 as illustrated in FIG. 2C, the second hydraulic fluid 132 can be loaded into the second cylinder 104, and can force the second piston 130 to move downward or proximally toward the first cylinder 102, thereby causing the first hydraulic fluid 116 to flow downward or distally toward the first cylinder 102, thereby causing the first piston 114 to move downward or distally along the cooling cylinder 118 toward the door 108 and away from the second cylinder 104. As the second piston 130 is forced to move along its stroke length downward toward the first cylinder 102 in this manner toward the position illustrated in FIG. 2A, the movement of the piston head 130a may pressurize the air within the first inner chamber within the second cylinder 104, and the pressurized air may be forced out of the second cylinder 104 through the valve 136.

As also illustrated in FIG. 2D, the door 108 of the first cylinder 102 includes a liquid water inlet port fitted with a liquid water inlet valve 142 through which liquid water can be loaded into the first inner chamber within the first cylinder 102. To load liquid water into the first inner chamber within the first cylinder 102, the first inner chamber may be cleared of other materials, such as solid water, the door 108 may be closed and secured in its closed position, such as by a latch or a clasp 144, a source of the liquid water may be coupled to the inlet valve 142, and the liquid water may be allowed to flow into and fill the first inner chamber through the valve 142. As the liquid water flows into the first inner chamber within the first cylinder 102, air may be trapped within the first inner chamber between the liquid water and the first piston 114. As the liquid water continues to flow, the liquid water may pressurize this air and the pressurized air may be forced out of the first cylinder 102 through the valve 146. The valve 146 is located at the top, proximal end of the first chamber within the first cylinder 102 so that the air can be vented out of the first cylinder 102 continuously as the liquid water is fed into the first cylinder 102.

In some implementations, the liquid water 112 loaded into the first cylinder 102 may be at or pre-chilled to approximately its freezing temperature, such that freezing of the liquid water within the first cylinder 102 occurs more quickly. Once the loading of the second hydraulic fluid 132 into the second cylinder 104 and the loading of the liquid water 112 into the first cylinder 102 is completed, the system 100 returns to the first configuration shown in FIG. 2A and the actions described above with respect to FIGS. 2A-2D may be repeated as many times and/or as frequently as desired.

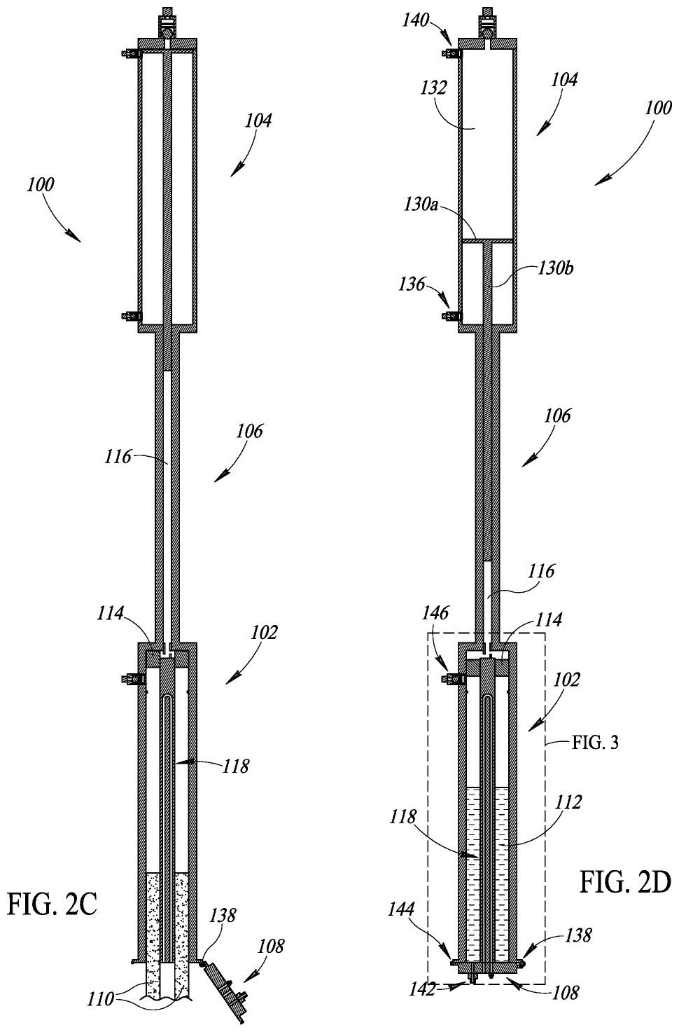

FIG. 3 illustrates a portion of FIG. 2D, as indicated in FIG. 2D, at a larger scale. As illustrated in FIG. 3, the first cylinder 102 includes a circumferential ridge 148 that protrudes from, or extends radially inward from, and that extends circumferentially around, the inner surface of the first cylinder 102. The ridge 148 has a cylindrical shape and has an inside diameter that is smaller than an inside diameter of the rest of the first cylinder 102. The ridge may be formed integrally or may be unitary with the first cylinder 102, or may be coupled thereto by mechanical or adhesive components. An outside diameter of the first piston 114 can be slightly smaller than the inside diameter of the first cylinder 102, such that an outer surface of the first piston 114 fits snugly within, and forms a seal with, the inside surface of the first cylinder 102. The outside diameter of the first piston 114 can also be larger than the inside diameter of the cylindrical shape of the ridge 148, such that the ridge 148 acts as a stop to prevent movement of the first piston 114 past the ridge 148.

As illustrated in FIG. 3, the ridge 148 is located below, or distal with respect to, the first piston 114, and is located within the first chamber within the first cylinder 102. In some cases, the specific location of the ridge 148 can be selected such that when the first piston 114, such as a lower surface thereof, is in contact with the ridge 148, such as an upper surface thereof, the volume of the second chamber within the first cylinder 102 is 9%, or about 9%, of the volume of the first chamber within the first cylinder 102. In such implementations, when the first piston 114 is positioned in contact with the ridge 148, the first chamber is filled with liquid water, and the liquid water is solidified or frozen, the water undergoes volumetric expansion of about 9% such that the first piston 114 travels along its entire stroke length and the first piston 114, such as an upper surface thereof, comes into contact with an upper, proximal wall, such as a lower surface thereof, at the upper, proximal end of the first cylinder 102.

As also illustrated in FIG. 3, the first cylinder 102 includes a perforated tube 150 that is coupled at a bottom, distal end thereof to a top, proximal end of the cooling cylinder 118, and at a top, proximal end thereof to an upper or a top, proximal wall of the first cylinder 102, such as at a location where the second chamber within the first cylinder 102 is fluidically coupled to the inner chamber within the third cylinder 106. The perforated tube 150 structurally and mechanically couples the cooling cylinder 118 to the first cylinder 102, while allowing the hydraulic fluid 116 to flow unimpeded between the second chamber within the first inner cylinder 102 and the inner chamber within the third cylinder 106.

While the first cylinder 102, the second cylinder 104, and the third cylinder 106 are described and illustrated herein as having cylindrical shapes, in alternative implementations, these components can have shapes other than cylinders. For example, these components can have conical or truncated cone shapes, with a larger one of the bases of such a shape located outward or distal with respect to a smaller one the bases. As other examples, these components can have prismatic or right prismatic shapes, with their bases having oval, elliptical, triangular, square, rectangular, or other shapes. As further examples, these components can have pyramidal or truncated pyramidal shapes, with a larger one of the bases of such a shape located outward or distal with respect to a smaller one of the bases, and with the bases having oval, elliptical, triangular, square, rectangular, or other shapes.

While the first cylinder 102 is described herein as including a single first chamber within which liquid water freezes, in alternative implementations, the first cylinder 102 may include a plurality of chambers or sub-chambers to which liquid water can be supplied and within which the liquid water can freeze. In some cases, such chambers or sub-chambers can be divided by walls made of copper, so that heat can be rapidly conducted between and out of or away from the chambers. Such embodiments can increase the rate at which water freezes within the system 100, such as by increasing a ratio of the surface area to the volume of the chambers within which the water freezes, as well as by decreasing an average distance between the copper walls and the individual water molecules.

In some implementations, the system 100 may include, in place of or in addition to the cooling cylinder 118, a heat pipe, which may be at least partially evacuated and/or which may carry a liquid and/or a gaseous working fluid to rapidly carry heat away from the water within the first chamber of the first cylinder 102. While the liquid 112 and the ice 110 are described herein as being made of water, in other implementations, materials other than water may be used. For example, any material that expands as it freezes may be used in place of the water described herein.

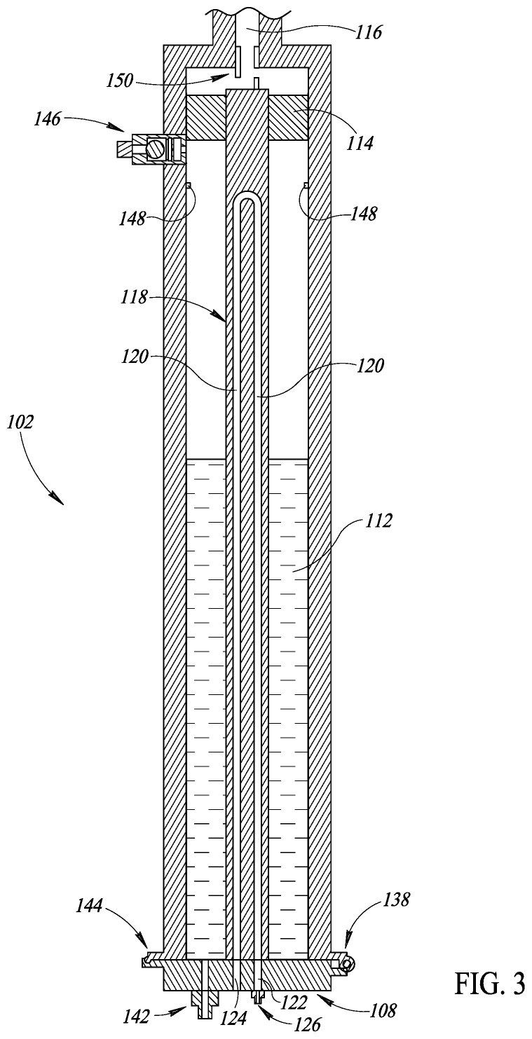

FIG. 4 illustrates an array of a plurality of systems 200 for generating mechanical work from a liquid-solid phase change, such as from the expansion of water as it freezes. Each of the systems 200 can have the same or similar features as the system 100 described herein. For example, each of the systems 200 may include a first, lower cylinder 202 having features that are the same as or similar to those of the first cylinder 102. The first cylinders 202 of each of the systems 200 can be positioned within an insulated reservoir or tank similar to the tank 128 but large enough to surround and hold each of the first cylinders 202. In some implementations, the inlets and outlets of the systems 200 can be the same as or similar to the inlets and outlets of the system 100 described herein, and can be coupled to one another, such as in a parallel arrangement, to improve the overall efficiency of the operation of the plurality of systems 200.

In some implementations, each of the systems 200 can be operated cyclically as described herein for the system 100, but with the cycles of the systems 200 staggered or offset equally from one another so that the array of systems 200 as a whole provides more constant or steady power. For example, if the array of systems 200 is coupled to a hydraulic motor with a demand of 10 liters per minute, and if the inner chamber within the second cylinder 104 has a volume of 2.5 liters, then the hydraulic motor requires that four freezing cycles be performed per minute. If a freezing cycle takes about one hour to perform, then an array of 240 systems 200, each operating with its freezing cycle offset from the others by 15 seconds, would provide the demanded flow rate and the corresponding power at a relatively steady state.

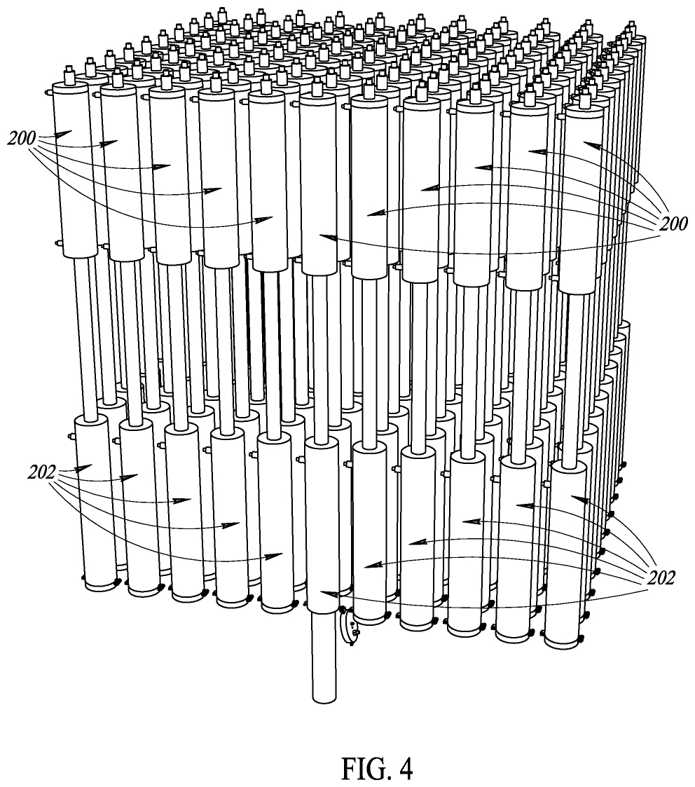

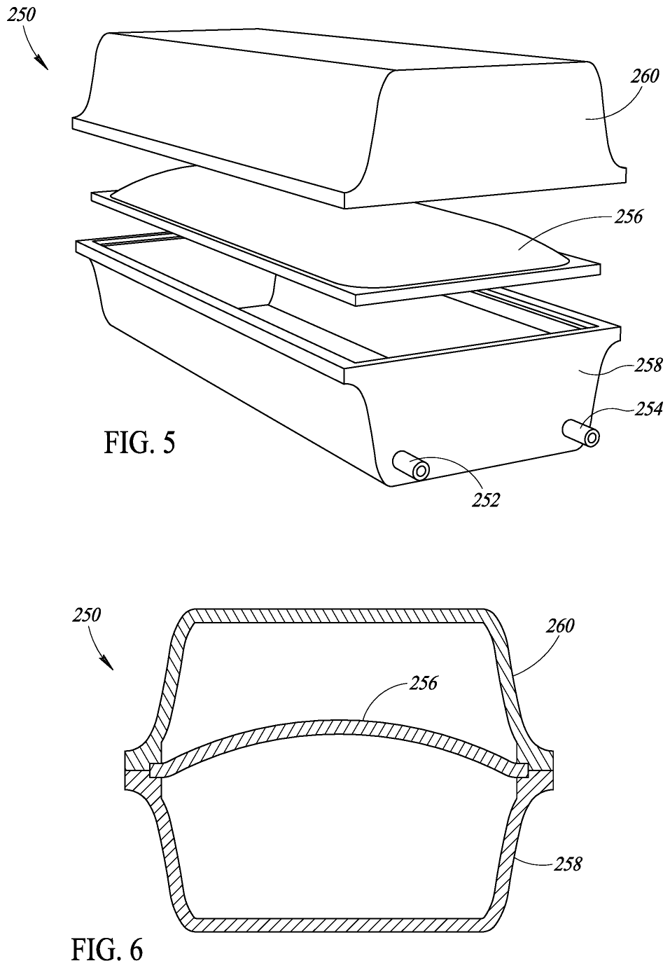

FIG. 5 illustrates an exploded view, and FIG. 6 illustrates a cross-sectional view, of a hydraulic accumulator 250. As illustrated in FIGS. 5 and 6, the hydraulic accumulator 250 can include a hydraulic fluid housing 258 that houses hydraulic fluid, a pressurized gas housing 260 that houses pressurized gas, such as at a pressure corresponding to an operating pressure of a selected hydraulic alternator and/or a selected hydraulic motor, and a membrane 256 that separates the hydraulic fluid housing 258 from the pressurized gas housing 260. The hydraulic accumulator 250 can be coupled to the system 100 or to the array of systems 200. For example, the hydraulic fluid housing 258 includes an inlet port 252 that can be coupled, such as via a hydraulic conduit and/or one or more valves, to the hydraulic fluid outlet valve 134 of the system 100 or to corresponding valves of the systems 200, and includes an outlet port 254 that can be coupled, such as via a hydraulic conduit and/or one or more valves, to the hydraulic fluid inlet valve 140 of the system 100 or to corresponding valves of the systems 200.

In some implementations, the outlet port 254 can be coupled, such as via a hydraulic conduit and/or one or more valves, to an inlet of the selected hydraulic alternator and/or the selected hydraulic motor. For example, such valves can include a flow control valve configured to control a flow rate and/or a pressure of the hydraulic fluid as it is supplied to the hydraulic alternator and/or to the hydraulic motor, such as to provide the hydraulic alternator and/or the hydraulic motor with the hydraulic fluid at a specified flow rate and/or at a specified pressure. An outlet of the hydraulic alternator and/or the hydraulic motor can be coupled, such as via a hydraulic conduit and/or one or more valves, to the hydraulic fluid inlet valve 140 of the system 100 or to corresponding valves of the systems 200. When the system 100 pumps the second hydraulic fluid 132 out of the second cylinder 104, the second hydraulic fluid 132 can flow out of the outlet valve 134 and then into the accumulator 250 through the inlet port 252, and when the second hydraulic fluid 132 is reloaded into the second cylinder 104, the second hydraulic fluid 132 can flow out of the accumulator 250 through the outlet port 254, through the hydraulic alternator and/or the hydraulic motor, and then into the second cylinder 104 through the inlet valve 140.

In such implementations, the hydraulic accumulator 250 can receive pressurized hydraulic fluid and corresponding energy from the system 100 or the systems 200, can store such energy in the deformation of the membrane 256, and can release the hydraulic fluid and corresponding energy as needed, thereby supplying power, to the hydraulic alternator and/or the hydraulic motor. In this manner, the hydraulic accumulator can smooth and/or regulate the delivery of the hydraulic fluid and hydraulic power from the system 100 or systems 200 to the hydraulic alternator and/or to the hydraulic motor.

The systems described herein for generating mechanical work from a liquid-solid phase change can be used to power residential homes or commercial or industrial facilities. In some implementations, the systems described herein can be used in Antarctica, in outer space, or on celestial bodies such as the Earth's moon, Mars, asteroids, etc. In general, the systems described herein are particularly efficient and useful in relatively cold environments (e.g., ambient temperatures below the freezing point of water), where a relatively large heat sink is readily available (e.g., permafrost regions), or where costs of freezing water (such as by using cold materials such as liquid nitrogen, dry ice, etc.) is lower than the costs of other fuels on a cost per kWh produced basis.

In any of the foregoing scenarios, a source of liquid water such as a water main or other plumbing, ground water, a river, a lake, an ocean, etc., or a reservoir of liquid water, such as constructed under a ground surface at a depth where the temperature is above the freezing point of water, or otherwise coupled to a location under a ground surface at a depth where the temperature is above the freezing point of water, such as by a heat pipe, can be drawn from to supply liquid water to the systems described herein. Freezing environmental temperatures or other heat sinks or cold materials can then be used to freeze the liquid water within the systems described herein. The frozen water can then be removed from the systems described herein and then be returned to the source or the reservoir of the liquid water, where the frozen water can melt and be made available for re-use in a subsequent freezing cycle within the systems described herein.

Any of the systems described herein can include any suitable control system, such as a computer operated control system, for controlling the operation of the system. Such a control system may include a computer running control software that controls the timing and operation of the valves described herein.

The systems described herein provide various advantages over conventional sources of power. For example, the systems described herein can generate mechanical work and power from a temperature differential alone and do not need or use any other source of energy, such as fossil fuels. The systems described herein are therefore capable of generating power without emissions, exhaust, or other by-products. The systems described herein can also provide a relatively large amount of power per unit volume taken up by the systems. For example, it has been determined that a system as described herein can occupy about 64 cubic feet, or a region of space having dimensions in each of three perpendicular dimensions of about four feet, while powering a typical American household or providing about 30 kWh per day. The systems described herein may also not use or consume any exotic, expensive, or toxic materials. Further, the systems described herein may be most useful at times when, and in regions where, solar power is least useful. For example, the systems described herein may be particularly useful in cold environments, during cold seasons, at cold times of day, and generally when the sun shines less.

The various implementations described above can be combined to provide further implementations. These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A system for generating mechanical work from a liquid-solid phase change, the system comprising:
a tank;
an outer housing at least partially inside the tank, the outer housing having an inner surface;
an inner housing at least partially inside the outer housing, the inner housing having an outer surface;
a piston located inside the outer housing and outside the inner housing, the piston having an outer surface engaged with the inner surface of the outer housing, the piston having an inner surface engaged with the outer surface of the inner housing;
an outer chamber between the tank and the outer housing, wherein in operation the outer chamber contains a first coolant at a temperature below zero degrees Celsius;
an intermediate chamber between the inner surface of the outer housing and the outer surface of the inner housing, wherein in operation the intermediate chamber contains a liquid water; and
an inner chamber inside the inner housing, wherein in operation the inner chamber contains a second coolant at a temperature below zero degrees Celsius.

2. The system of claim 1 wherein the outer housing includes an air intake valve that allows air to flow into and out of the intermediate chamber.

3. The system of claim 1 wherein the outer housing is cylindrical, the inner housing is cylindrical, and the intermediate chamber is annular.

4. The system of claim 1, further comprising a hydraulic fluid chamber inside the outer housing, wherein in operation the hydraulic fluid chamber contains a hydraulic fluid.

5. The system of claim 4 wherein the piston separates the intermediate chamber from the hydraulic fluid chamber and in operation separates the liquid water from the hydraulic fluid.

6. The system of claim 5, further comprising a hydraulic cylinder coupled to the outer housing and a second piston inside the hydraulic cylinder.

7. The system of claim 6 wherein, when in operation and the liquid water freezes, expansion of the liquid water causes movement of the piston, movement of the piston causes the hydraulic fluid to flow, and flow of the hydraulic fluid causes movement of the second piston.

8. The system of claim 7 wherein movement of the second piston causes a second hydraulic fluid to flow into an accumulator.

9. The system of claim 7 wherein movement of the second piston causes a second hydraulic fluid to flow into a hydraulic alternator.

10. The system of claim 7 wherein movement of the second piston causes a second hydraulic fluid to flow into a hydraulic motor.

11. The system of claim 1, further comprising:
a second outer housing at least partially inside the tank, the second outer housing having a second inner surface;
a second inner housing at least partially inside the second outer housing, the second inner housing having a second outer surface;
a second piston located inside the second outer housing and outside the second inner housing, the second piston having a second outer surface engaged with the second inner surface of the second outer housing, the second piston having a second inner surface engaged with the second outer surface of the second inner housing;
a second outer chamber between the tank and the second outer housing, wherein in operation the second outer chamber contains a third coolant at a temperature below zero degrees Celsius;
a second intermediate chamber between the second inner surface of the second outer housing and the second outer surface of the second inner housing, wherein in operation the second intermediate chamber contains liquid water; and
a second inner chamber inside the second inner housing, wherein in operation the second inner chamber contains a fourth coolant at a temperature below zero degrees Celsius.

12. A method of generating mechanical work from a liquid-solid phase change, the method comprising:
supplying liquid water to an intermediate chamber between an outer housing and an inner housing;
supplying a first coolant to an outer chamber between a tank and the outer housing, the first coolant at a temperature below zero degrees Celsius;
supplying a second coolant to an inner chamber inside the inner housing, the second coolant at a temperature below zero degrees Celsius; and
allowing the liquid water to freeze inside the intermediate chamber as heat is transferred from the liquid water through the outer housing to the first coolant and through the inner housing to the second coolant, the freezing of the water forcing a piston to move between the outer housing and the inner housing along a length of the outer housing and along a length of the inner housing.

13. The method of claim 12, further comprising opening a door of the outer housing and removing frozen water from the intermediate chamber.

14. The method of claim 12, further comprising:
supplying liquid water to a second intermediate chamber between a second outer housing and a second inner housing;
supplying a third coolant to a second outer chamber between the tank and the second outer housing, the third coolant at a temperature below zero degrees Celsius;
supplying a fourth coolant to a second inner chamber inside the second inner housing, the fourth coolant at a temperature below zero degrees Celsius; and
allowing the liquid water to freeze inside the second intermediate chamber as heat is transferred from the liquid water through the second outer housing to the third coolant and through the second inner housing to the fourth coolant, the freezing of the water forcing a second piston to move between the second outer housing and the second inner housing along a length of the second outer housing and along a length of the second inner housing.

15. The method of claim 14 wherein a freezing cycle of water within the intermediate chamber is offset from a freezing cycle of water within the second intermediate chamber.
